(19) United States
(12) Patent Application Publication
(10) Pub. No.: US 2026/0113766 A1
(43) Pub. Date: Apr. 23, 2026

(54) Repeater Latency Signaling

(71) Applicant: Telefonaktiebolaget LM Ericsson (publ), Stockholm (SE)

(72) Inventors: Behrooz Makki, Pixbo (SE); Magnus Åström, Lund (SE); Boris Dortschy, Vendelsö (SE); Lei Bao, Göteborg (SE)

(21) Appl. No.: 18/881,582

(22) PCT Filed: Jul. 28, 2023
(86) PCT No.: PCT/EP2023/071044

§ 371 Date: Jan. 6, 2025

Related U.S. Application Data
(60) Provisional application No. 63/393,366, filed on Jul. 29, 2022.

(51) Int. Cl. H04W 72/51; H04B 7/04; H04L 5/00; H04L 5/14; H04W 72/231; H04W 72/25

(52) U.S. Cl. CPC H04W 72/51; H04B 7/04013; H04L 5/0053; H04L 5/1469; H04W 72/231; H04W 72/25

(57) ABSTRACT

Systems and methods for repeater latency signaling are provided. In some embodiments, a method performed by a first network node includes: providing a repeater latency capability to a second network node; receiving a repeater side control information; and applying the repeater side control information at an application time instant according to a latency configuration. The latency configuration or the repeater side control information is related to: repeater beam switching; repeater-Fwd ON/OFF; repeater power control; or control signal decoding. In this way, the second network node (e.g., gNB) can be informed about the NCR latency and can have proper synchronization. This enables the proper integration of the NCRs into the network and, hence, improve the coverage extension.

### RELATED APPLICATIONS

This application claims the benefit of provisional patent application Ser. No. 63/393,366, filed Jul. 29, 2022, the disclosure of which is hereby incorporated herein by reference in its entirety.

### TECHNICAL FIELD

The present disclosure generally relates to configuring a repeater node.

### BACKGROUND

To increase the data rate and support the increasing number of UEs, different methods are considered, among which network densification and millimeter wave (mmW) communications are the dominant ones. Network densification refers to the deployment of multiple access points of different types in, e.g., metropolitan areas. Particularly, it is expected that in future small nodes, such as relays, IABs, repeaters, etc., will be densely deployed to support existing macro base stations (BS) serving UEs.

During the 3GPP Release 16 (Rel-16) and Rel-17, Integrated Access and Backhaul (IAB) has been well studied as the main relaying technique in 5G, and the discussions will continue in Rel-18 on Mobile IAB. Here, using decode-and-forward relaying technique, the IAB can well extend the coverage and/or increase the throughput. However, IAB may be a relatively complex and expensive node and thereby, depending on the deployment, alternative nodes may be required with low complexity/cost for, e.g., blind spot removal. Here, a candidate type of network node is the radio frequency (RF) repeaters which simply amplify-and-forward any signal that they receive. RF repeaters have been considered in 2G, 3G, and 4G to supplement the coverage provided by regular full-stack cells. However, RF repeater lacks in, e.g., accurate beamforming which may limit its efficiency in, for instance, FR2.

With this background, a new study-item has been considered in 3GPP Rel-18, started in May 2022, in which the potentials and the challenges of Network-Controlled Repeaters (NCR) will be evaluated. In one alternative, a network-controlled repeater can be a normal repeater with beamforming capabilities. In this way, the NCR should be considered as a network-controlled “beam bender” when compared to a gNB. As such, it is logically part of the gNB for all management purposes, i.e., it is likely that the NCR is deployed and under the control of the operator. NCR is based on an amplify-and-forward relaying scheme, and it is likely to be limited to single-hop communication in stationary deployments with the focus on FR2. In other words, NCR is an enhancement over conventional RF repeaters with the capability to receive and process side control information from the network. Side control information could allow an NCR to perform an amplify-and-forward operation in a more efficient manner. Potential benefits could include, for instance, mitigation of unnecessary noise amplification, transmissions and receptions with better spatial directivity, simplified network integration, etc.

The Rel-18 study-item focuses on several key aspects of NCR-based communications. In particular, the NR SID (See, RP-213700, “New SID on NR Network Controlled Repeaters,” 3GPP TSG RAN Meeting #94c. Dec. 6-17, 2021, referred to herein as “[1]”) considers the following for the study-item:
a. Network-controlled repeaters are inband RF repeaters used for extension of network coverage on FR1 and FR2 bands, while during the study FR2 deployments may be prioritized for both outdoor and O2I scenarios.
b. For only single hop stationary network-controlled repeaters
c. Network-controlled repeaters are transparent to UEs
d. Network-controlled repeater can maintain the gNB-repeater link and repeater-UE link simultaneously

Also, the study-item will concentrate on identifying which side control information is required regarding [1]:
a. Beamforming information
b. Timing information to align transmission/reception boundaries of network-controlled repeater
c. Information on UL-DL TDD configuration
d. ON-OFF information for efficient interference management and improved energy efficiency
c. Power control information for efficient interference management

The scope and the features of NCR are still under discussion. FIG. 1 gives an example of an NCR deployment. Here, the NCR consists of two principal building blocks, namely, the NCR mobile termination (NCR-MT) and the NCR forwarding (NCR-Fwd) functions. Particularly, the following terminologies and definitions have been agreed in RAN1 #109-e (See, “Chairman's Notes”, 3GPP TSG RAN WG1 Meeting #109-e, May 2022 referred to herein as “[2]”):

### Agreement

Capture the following model of network-controlled repeater in TR 38.867.
a. The NCR-MT is defined as a function entity to communicate with a gNB via Control link (C-link) to enable the information exchanges (e.g., side control information). The C-link is based on NR Uu interface.
   i. Note: Side control information is at least for the control of NCR-Fwd
b. The NCR-Fwd is defined as a function entity to perform the amplify-and-forwarding of UL/DL RF signal between gNB and UE via backhaul link and access link. The behavior of the NCR-Fwd will be controlled according to the received side control information from gNB.

The NCR is equipped with an antenna configuration, where a signal is first received in downlink (or uplink), and, e.g., after power amplification, transmitted further in downlink (or uplink). Since the NCR-Fwd module only amplifies and (analogously) beamforms the signal, no advanced receiver or transmitter chains are required, which reduce the cost and energy consumption compared to, for example, a normal Transmission and Reception Point (TRP). In its simplest (and, practical) architecture, different antenna modules are used for the BS- and UE-sides, i.e., the antennas targeting the gNB and UEs, respectively, whereas a more complex architecture, including self-interference cancellation, would allow for using the same antenna modules for both sides.

The NCR-MT module is able and used to exchange control and status signaling with a gNB, in the C-link shown in FIG. 1, that is controlling the NCR. For this, the NCR-MT module supports at least a sub-set of UE functions. In the BS-side, the NCR-MT module might be equipped with antennae separated from the antennae used by the NCR-Fwd module. However, in most configurations, at the BS-side, the NCR-MT and NCR-Fwd modules will share antenna configurations. Particularly, motivated by cost-efficient implementation and a unified beamforming framework for the NCR-MT and NCR-Fwd functionalities, it is beneficial to have an architecture with shared NCR-MT and NCR-Fwd antennas on the BS-side.

In general, the NCR-MT and the NCR-Fwd modules could be operating at the same or different frequencies. For example, the NCR-Fwd could operate at a high frequency band (FR2) and the NCR-MT could be operating at a low frequency band (FR1). However, controlling the backhaul link will be much simplified if the NCR-MT and NCR-Fwd operate in the same carrier. Regarding the BS-side, the following points have been agreed in RAN1 #109-e [2]:

### Agreement

Capture the following assumption of network-controlled repeater in TR 38.867.
a. At least one of the NCR-MT's carrier(s) should be within the set of carriers forwarded by the NCR-Fwd in same frequency range.
   i. The NCR-MT and NCR-Fwd operating in the same carrier is prioritized for the study.

### Agreement

Capture the following assumption of network-controlled repeater in TR 38.867.
a. As baseline, same large-scale properties of the channel, i.e., channel properties in Type-A and Type-D (if applicable), are expected to be experienced by C-link and backhaul link (at least when the NCR-MT and NCR-Fwd operating in same carrier).

### Agreement

As baseline, the same TCI states as C-link are assumed for beam at NCR-Fwd for backhaul link if the NCR-MT's carrier(s) is within the set of carriers forwarded by the NCR-Fwd.
a. FFS: additional indication from gNB to determine the beam at NCR-Fwd for backhaul link or implicit determination of the beam at NCR-Fwd for backhaul link

Note: the same assumption of the beam correspondence is applied for DL/UL of the backhaul link at NCR-Fwd as the DL/UL of the C-link at NCR-MT.

The NCR-Fwd's amplify-and-forward operation is controlled by the NCR-MT. The NCR-MT could also be directly responsible for the beamforming control on the access antenna side, i.e., to/from served UEs. In an alternative, the beamforming on the access antenna side is operated by the NCR-Fwd under control of the NCR-MT. On the BS antenna side, i.e., to/from the controlling gNB, the NCR-MT could be directly responsible for the beamforming control. Here, it is important to note that the beam control of the NCR UE-side should be conducted smoothly to minimize the impact on cell-common and UE-specific signals/channels which are forwarded towards the UEs. Also, a beam arrangement including both wider and narrower beams is required to accommodate both broadcast and unicast signals. With respect to UE-side beamforming, the following agreements have been reached in RAN1 #109-e [2]:

### Agreement

At least for FR2, beam information is beneficial and recommended as the side control information for network-controlled repeater to control the behavior of NCR at least for access link
a. FFS: Detailed mechanism of indication.
b. Note: There are no supporting evaluation results on FR1 at this point to reach similar conclusion

### Agreement

Both the dynamic indication and semi-static indication can be considered for the beam of access link for NCR-Fwd.
a. FFS: the details of each indication
b. FFS: the maximum number of beams configured for NCR-Fwd access link

### Agreement

In the access link beam indication, an access link beam can be indicated by:
a. Option 1: A beam index
   i. FFS: How to indicate the corresponding time domain resource of the beam.
b. Option 2: An index of a source RS (e.g., a TCI-like indicator)
   i. FFS: The definition of the source RS.
   ii. FFS: How to indicate the corresponding time domain resource of the beam.
   iii. FFS: The definition of the association between the source RS and the beam.
c. Note: The above does not imply that the NCR can or cannot generate and transmit reference signals to a UE or receive and process reference signals from a UE.

RAN1 to select one of the two options, combine the two options, or select both options in RAN1 #110

### Agreement

From the perspective of signaling design, following mechanisms can be considered for the access link beamforming of the NCR-Fwd.
a. Option #2-1: Dynamic beam indication only
b. Option #2-2: Semi-static beam indication only
c. Option #2-3: Dynamic beam indication and semi-static beam indication

In 3GPP, timing and time synchronization are very much identified and discussed as frame(-start) timing. In an NCR-assisted network, any signal timing is solely determined by gNB and UE transmission timing, and the NCR has no control of any transmit or reception signal timing. However, the NCR needs to know when a certain beam should be applied and when switching to a subsequent beam should take place. For this reason, knowledge of frame timing is required. Here, legacy UE mechanism is sufficient to achieve DL/UL timing for the NCR-MT. That is, the DL receiving timing and the UL transmitting timing of the NCR-Fwd can, respectively, be aligned with the DL receiving timing and the UL transmission timing of the NCR-MT.

In practice, the NCR-MT will receive some information and that configuration should be applied. Then, how long it takes to receive and apply (decoding delay of the NCR-MT) should be considered. Particularly, the impact of internal delay on the following timing relationships should be considered:
a. The DL receiving timing and DL transmitting timing of the NCR-Fwd
b. The UL transmitting timing and UL receiving timing of the NCR-Fwd.

With this respect the following agreements have been reached in RAN1 #109-e [2]:

### Agreement

The time at which the NCR applies an access link beam indication should be considered.

### Conclusion

Legacy UE mechanism is sufficient to achieve DL/UL timing for NCR-MT.

### Agreement

For the signaling of the side control information of timing to align transmission/reception boundaries, new signaling may be unnecessary.
a. FFS: the impact of internal delay

### Agreement

For the timing of NCR, the following assumption is considered as baseline:
a. The DL receiving timing of the NCR-Fwd is aligned with the DL receiving timing of the NCR-MT.
b. The UL transmitting timing of the NCR-Fwd is aligned with the UL transmitting timing of the NCR-MT.
c. FFS: the impact of internal delay on the following timing relationships:
   i. The DL receiving timing and DL transmitting timing of the NCR-Fwd
   ii. The UL transmitting timing and UL receiving timing of the NCR-Fwd

### Resource Allocation in Time Domain and ACK/NACK Response Timing

In NR, resource allocation should be defined both in time domain and frequency domain. Particularly, in NR the time domain resource allocation is determined by much more complicated rules than in LTE. When operating in TDD mode, the UEs need to be aware when to expect the transmission (UL) and when to expect the reception (DL) in terms of slots. Here, the slot pattern can be defined in a flexible way based on parameters and communicated to the UE via RRC. Particularly, three ‘K’ values are defined in 5G NR that govern time domain slot and symbol level resource allocation (See TS 38.214. “NR: Physical layer procedures for data”. V17.2.0, 3GPP. June 2022 referred to herein as “[3]”):

### PDSCH—Time Domain Allocation (DCI—PDSCH Timing)

K0 is the offset between the DL slot where the PDCCH/DCI for DL scheduling is received and the DL slot where PDSCH data is scheduled. In other words. K0 is the time delay between DCI slot and scheduled PDSCH slot, as illustrated in FIG. 2 (based on drawings from https://www.linkedin.com/pulse/5g-nr-k0k1-k2-time-domain-dl-ul-resource-allocation-naveen-chelikani). In NR. DCI formats 1_0 and 1_1 are used to dynamically allocate time-domain resources for PDSCH. When the subcarrier spacing of PDSCH and PDCCH is different, the time delay between DCI slot reception and scheduled PDSCH slot is a little different from K0 value, but when the subcarrier spacing of PDSCH and PDCCH is the same, the time delay between DCI slot reception and scheduled PDSCH slot becomes K0 (see [3] for details). Generally, it can be assumed that PDSCH subcarrier spacing is configured to the same as PDCCH subcarrier spacing.

In general, the offset can be in the slot or symbol level. Particularly, according to 38.214 [3], when the UE is scheduled to receive PDSCH by a DCI, the Time domain resource assignment field value m of the DCI provides a row index m+1 to an allocation table. The determination of the used resource allocation table is defined in [3. Clause 5.1.2.1.1]. The indexed row defines the slot offset K0, the start and length indicator SLIV, or directly the start symbol S and the allocation length L, and the PDSCH mapping type to be assumed in the PDSCH reception. To find out how to determine the symbol S and the allocation length L and all valid combinations of S and L, see [3. Section 5.1.2.1] and [3. Table 5.1.2.1-1], respectively.

### PDSCH—ACK/NACK Timing

K1 is the offset between the DL slot where the data is scheduled on PDSCH and UL slot where the ACK/NACK feedback for the scheduled PDSCH data needs to be sent. In other words. K1 indicates the time delay between a received PDSCH slot and UCI (ACK/NACK) slot, as shown in FIG. 2. FIG. 2 is an illustration of K0 and K1 parameters. Note that, the same as in DCI-PDSCH timing, the PDSCH-ACK/NACK timing can also be set in the symbol level [3. Section 5.3].

### PUSCH—Time Domain Allocation:

K2 is the offset between the DL slot where the PDCCH (DCI) for UL scheduling is received and the UL slot where the UL data needs to be sent on PUSCH. In other words. K2 is the time delay between DCI slot reception and PUSCH transmission slot, as illustrated in FIG. 3 (based on drawings from https://www.linkedin.com/pulse/5g-nr-k0k1-k2-time-domain-dl-ul-resource-allocation-naveen-chelikani). FIG. 3 is an illustration of K2 parameter. Note that when the subcarrier spacing of PUSCH and PDCCH is different, the time delay between DCI slot reception and PUSCH slot transmission is a little different from K2 value, but when the subcarrier spacing of PUSCH and PDCCH is the same, the time delay between DCI slot reception and PUSCH slot transmission becomes K2 (see [3] for details). Generally, it can be assumed that PDSCH subcarrier spacing is configured to the same as PDCCH subcarrier spacing.

Here, the same as above, the offset can be in the slot level (by indication of the slot offset K2, the start and length indicator SLIV) or in the symbol level by directly determining the start symbol S and the allocation length L (see [3, Section 6.1.2.1]).

### Reconfigurable Intelligent Surface (RIS)

Intelligent reflecting surface (IRS), also known as Reconfigurable intelligent surface (RIS), is an emerging technology that is capable of intelligently manipulating the propagation of electro-magnetic waves. RIS is composed of a 2-dimensional array of reflecting elements, where each element acts as a passive reconfigurable scatterer, i.e., a piece of manufactured material, which can be programmed to change an impinging electro-magnetic wave in a customizable way. Such elements are usually low-cost passive surfaces that do not require dedicated power sources, and the radio waves impinged upon them can be forwarded without the need of employing power amplifier or RF chain. Moreover, RIS can, potentially, work in full duplex mode without significant self-interference or increased noise level and requires only low-rate control link or backhaul connections. RIS can be flexibly deployed due to its low weight and low power consumption. Specially, RIS is of interest in stationary or low-mobility networks, in which the transmission parameters can be well planned and, e.g., blockages/tree foliage is bypassed through RIS-assisted communication.

There are still ambiguities about the detailed differences of the network-controlled repeaters and RISs. A simple explanation is that a RIS is a network-controlled repeater with negative amplification. In general, RIS is expected to be a simpler and cheaper node with less focused beamforming capability/accuracy and without active amplification. That is, RIS may be capable of signal reflection via adapting a phase matrix while the network-controlled repeater is capable of advanced beamforming with power amplification. Also, delay wise, RIS may have slightly lower latency, compared to network-controlled repeater. In 3GPP, RIS-assisted communication has been recently suggested by some companies as a possible technology to be considered in Rel-18 network-controlled repeater study-item. For instance, RIS has been discussed in 3GPP TSG RAN Rel-18 workshop, June 2021 (See RWS-210300, “NR repeaters and Reconfigurable Intelligent Surface” 3GPP TSG RAN Rel-18 workshop, June 2021). Then, while specification wise a network-controlled repeater is likely to be a superset of the RIS, it is not unlikely that RIS-specific features are discussed in the Rel-18 study-item on network-controlled repeaters.

A RIS might have a similar design as the network-controlled repeater exemplified in FIG. 1, but without the signal amplification.

### NR Multi-Beam Operation

### Beam Management Procedure

In high frequency range (FR2), multiple RF beams may be used to transmit and receive signals at a gNB and a UE. For each DL beam from a gNB, there is typically an associated best UE Rx beam for receiving signals from the DL beam. The DL beam and the associated UE Rx beam forms a beam pair. The beam pair can be identified through a so-called beam management process in NR.

A DL beam is (typically) identified by an associated DL reference signal (RS) transmitted in the beam, either periodically, semi-persistently, or aperiodically. The DL RS for the purpose can be a Synchronization Signal Block (SSB) which can include a Primary Synchronization Signal (PSS), a Secondary Sync Signal (SSS), and a Physical Broadcast Channel (PBCH) or a Channel State Information-Reference Signal (CSI-RS). By measuring all the DL RSs, the UE can determine and report to the gNB the best DL beam to use for DL transmissions. The gNB can then transmit a burst of different DL-RSs in the reported best DL beam to let the UE evaluate candidate UE RX beams.

FIG. 4 is an example of beam management procedure. Although not explicitly stated in the NR specification, beam management has been divided into three procedures, schematically illustrated in FIG. 4:
P-1: Purpose is to find a coarse direction for the UE using wide gNB TX beam covering the whole angular sector.
P-2: Purpose is to refine the gNB TX beam by doing a new beam search around the coarse direction found in P-1.
P-3: Used for UE that has analog beamforming to let them find a suitable UE RX beam.

P-1 is expected to utilize beams with rather large beamwidths and where the beam reference signals are transmitted periodically and are shared between all UEs of the cell. Typically reference signal to use for P-1 are periodic CSI-RS or SSB. The UE then reports the N best beams to the gNB and their corresponding RSRP values.

P-2 is expected to use aperiodic/or semi-persistent CSI-RS transmitted in narrow beams around the coarse direction found in P-1.

P-3 is expected to use aperiodic/or semi-persistent CSI-RSs repeatedly transmitted in one narrow gNB beam. One alternative way is to let the UE determine a suitable UE RX beam based on the periodic SSB transmission. Since each SSB consists of four OFDM symbols, a maximum of four UE RX beams can be evaluated during each SSB burst transmission. One benefit with using SSB instead of CSI-RS is that no extra overhead of CSI-RS transmission is needed.

### Beam Indication

In NR, several signals can be transmitted from different antenna ports of a same base station. These signals can have the same large-scale properties such as Doppler shift/spread, average delay spread, or average delay. These antenna ports are then said to be quasi co-located (QCL).

If the UE knows that two of its antenna ports are QCL with respect to a certain parameter (e.g., Doppler spread), the UE can estimate that parameter based on one of the antenna ports and apply that estimate for receiving signal on the other antenna port.

For example, there may be a QCL relation between a CSI-RS for tracking RS (TRS) and the PDSCH DMRS. When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:

Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to also receive this signal.

In NR, the spatial QCL relation for a DL or UL signal/channel can be indicated to the UE by using a “beam indication”. The “beam indication” is used to help the UE to find a suitable RX beam for DL reception, and/or a suitable TX beam for UL transmission. In NR, the “beam indication” for DL is conveyed to the UE by indicating a transmission configuration indicator (TCI) state to the UE, while in UL the “beam indication” can be conveyed by indicating a DL-RS or UL-RS as spatial relation (in NR Rel-15/16) or a TCI state (in NR Rel-17).

### Beam Link Failure Procedure

Blocking is expected to be common in the above 6 GHz regime due to the narrow beams used at both the TRP and UE and the high penetration loss and diffraction loss at these high frequencies. To handle blocking at higher frequencies in NR a beam recovery procedure has been standardized (instead of relying on radio link failure (RLF) which is a much more costly and time-consuming procedure). The purpose of the beam recovery procedure is to find an alternative beam pair link (BPL) in case the active beam pair link is blocked, as illustrated in FIG. 5. FIG. 5 is an example of beam failure recovery mechanism. The UE beam failure recovery mechanism consists of four parts:

### Beam Failure Detection

The UE detects beam failure by monitoring a dedicated reference signal (CSI-RS or SSB) that is spatially QCL with PDCCH and assesses if a trigger condition has been met. The trigger condition is based on BLER for a hypothetical PDCCH based on the measurements on the dedicated DL-RS. A trigger condition is met (i.e., a beam link failure is declared) if the BLER for the hypothetical PDCCH is above a given threshold for X number of consecutive occasions (where X is configurable).

### New Candidate Beam Identification

In order to quickly find a candidate BPL after a beam link failure, the UE constantly monitors (i.e., measures RSRP on) beam identification RSs, which for example can be SSB (or periodic CSI-RS if configured). Since SSB is expected to be beamformed at higher frequencies to attain coverage, the UE can determine a preferred candidate TRP SSB beam based on these measurements. Since each SSB consists of four OFDM symbols, the UE can also perform a UE RX beam sweep during each SSB transmission, and hence it is possible for the UE to determine both a suitable TRP beam and UE beam for the candidate BPL.

### Beam Failure Recovery Request Transmission

When the UE has declared a beam link failure and a new candidate beam has been determined, the UE transmits a beam failure recovery request (BFRQ) on UL to notify the network about the beam link failure. The BFRQ is a PRACH which implicitly informs the TRP about the preferred TRP SSB beam.

### UE Monitors gNB Response for BFRQ Response

UE monitors for a BFRQ response from the network on the new candidate BPL to finalize the beam link recovery procedure.

Improved systems and methods for configuring repeater nodes is needed.

### SUMMARY

Systems and methods for repeater latency signaling are provided. In some embodiments, a method performed by a first network node for forwarding a signal to and/or from a User Equipment (UE) the method comprising: providing a repeater latency capability to a second network node; receiving a repeater side control information from the second network node; and applying the repeater side control information at an application time instant according to a latency configuration. In some embodiments, one or more of the latency configuration and the repeater side control information are related to one or more of: repeater beam switching; repeater-Fwd ON/OFF; repeater power control; and control signal decoding. In some embodiments, the first network node comprises at least one of: a repeater node, a Network Controlled Repeater (NCR); an Intelligent Reflecting Surface (IRS); a Reconfigurable Intelligent Surface (RIS); and a node with similar functionalities. In some embodiments, the second network node comprises at least one of: a base station; an Integrated Access and Backhaul (IAB) node which has an assisting repeater node; and a gNB. In this way, the gNB can be informed about the Network-Controlled Repeater (NCR) latency and can have proper synchronization. Particularly, some embodiments enable the proper integration of the NCRs into the network and, hence, improve the coverage extension.

In some embodiments, the method further comprises: receiving the latency configuration from the second network node.

In some embodiments, the repeater latency capability is further related to one or more of: repeater beam switching; repeater-Fwd ON/OFF; repeater power control; and control signal decoding.

In some embodiments, the repeater side control information is received via one or more of: a Medium Access Control-Control Element, MAC-CE, message; and Downlink Control Information, DCI, signaling.

In some embodiments, one or more of the repeater latency capability and the repeater latency configuration indicates a minimum required latency.

In some embodiments, the minimum required latency configured by second network node is different from the minimum required latency reported by the first network node.

In some embodiments, one or more of: the repeater side control information and the latency configuration indicate an application time instant in relation to reception instant of the repeater side control information.

In some embodiments, the repeater side control information comprises one or more of: a frame offset; a slot offset; and a symbol offset.

In some embodiments, the application time instant can be implicitly or explicitly configured.

In some embodiments, the application time instant is implicitly configured and is based on a repeater node capability report.

In some embodiments, the repeater side control information relates to one of more of: Uplink, UL; and Downlink, DL.

In some embodiments, the application time instant depends on the Time Domain Duplexing, TDD, direction, such that one or more of: a DL slot is applied in relation to a DL timing reference; an UL slot is applied in relation to an UL timing reference; and an UL slot is applied in relation to a DL timing reference.

In some embodiments, the method further comprises, upon receiving the repeater side control information, transmitting an Acknowledge, ACK, to the second network node.

In some embodiments, the second network node comprises at least one of: a base station; an Integrated Access and Backhaul, IAB, node which has an assisting repeater node; and a New Radio Base Station, gNB.

In some embodiments, the first network node comprises at least one of: a repeater node, a Network Controlled Repeater, NCR; an Intelligent Reflecting Surface, IRS; a Reconfigurable Intelligent Surface, RIS; and a node with similar functionalities.

In some embodiments, a method performed by a second network node for communicating with a user equipment, the method comprising: receiving a repeater latency capability from a first network node; determining a repeater side control information; transmitting the repeater side control information to the first network node; and transmitting or receiving a signal to the user equipment, via the first network node, according to a latency configuration; where one or more of the latency configuration and the repeater side control information are further related to one or more of: repeater beam switching; repeater-Fwd ON/OFF; repeater power control; and control signal decoding.

In some embodiments, the method further comprises: transmitting the latency configuration to the first network node.

In some embodiments, the latency capability is further related to one or more of: repeater beam switching; repeater-Fwd ON/OFF; repeater power control; and control signal decoding.

In some embodiments, the repeater side control information is transmitted via one or more of: a Medium Access Control-Control Element, MAC-CE, message; and Downlink Control Information, DCI, signaling.

In some embodiments, one or more of the repeater latency capability and the repeater latency configuration indicates a minimum required latency.

In some embodiments, the minimum required latency configured by second network node is different from the minimum required latency reported by the first network node.

In some embodiments, one or more of: the repeater side control information and the latency configuration indicate an application time instant in relation to reception instant of the indication.

In some embodiments, the latency configuration comprises one or more of: a frame offset; a slot offset; and a symbol offset.

In some embodiments, the application time instant can be implicitly or explicitly configured.

In some embodiments, the indication relates to one of more of: Uplink, UL; and Downlink, DL.

In some embodiments, the application time instant depends on the Time Domain Duplexing, TDD, direction, such that one or more of: a DL slot is applied in relation to a DL timing reference; an UL slot is applied in relation to an UL timing reference; and an UL slot is applied in relation to a DL timing reference.

In some embodiments, the latency configuration depends on a subcarrier spacing of PDSCH, PDCCH, PUSCH, or PDCCH.

In some embodiments, the method further comprises: receiving an ACK for the reception of the repeater side control information from the first network node.

In some embodiments, the second network node comprises at least one of: a base station; an Integrated Access and Backhaul, IAB, node which has an assisting repeater node; and a gNB.

In some embodiments, the first network node comprises at least one of: a repeater node, a Network Controlled Repeater, NCR; an Intelligent Reflecting Surface, IRS; a Reconfigurable Intelligent Surface, RIS; and a node with similar functionalities.

In some embodiments, a first network node for forwarding a signal to/from a User Equipment, UE, comprises processing circuitry and memory, the memory comprising instructions to cause the first network node to: provide a repeater latency capability to a second network node; receive a repeater side control information from the second network node; and apply the repeater side control information at an application time instant according to a latency configuration; where one or more of the latency configuration and the repeater side control information are further related to one or more of: repeater beam switching; repeater-Fwd ON/OFF; repeater power control; and control signal decoding. In other words, the first network node is configured to perform any of the methods disclosed herein.

In some embodiments, a second network node for communicating with a User Equipment, UE, comprises processing circuitry and memory, the memory comprising instructions to cause the second network node to: receive a repeater latency capability from a first network node; determine a repeater side control information; transmit the repeater side control information to the first network node; and transmit or receive a signal to the user equipment, via the first network node, according to a latency configuration; where one or more of the latency configuration and the repeater side control information are further related to one or more of: repeater beam switching; repeater-Fwd ON/OFF; repeater power control; and control signal decoding. In other words, the second network node is configured to perform any of the methods disclosed herein.

In some embodiments, a computer-readable medium comprises instructions which, when executed on at least one processor, cause the at least one processor to carry out the method according to any one of claims.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a conceptual model of a Network-Controlled Repeater (NCR);

FIG. 2 illustrates how K0 is the offset between the DL slot where the PDCCH/DCI for DL scheduling is received and the DL slot where PDSCH data is scheduled;

FIG. 3 illustrates how K2 is the offset between the DL slot where the PDCCH (DCI) for UL scheduling is received and the UL slot where the UL data needs to be sent on PUSCH;

FIG. 4 is an example of beam management procedures divided into three procedures;

FIG. 5 is an example of beam failure recovery mechanism;

FIG. 6 illustrates a flowchart of some embodiments from the repeater perspective, according to some embodiments of the current disclosure;

FIG. 7 illustrates a flowchart of some embodiments from the gNB perspective, according to some embodiments of the current disclosure;

FIG. 8 shows an example of a communication system in accordance with some embodiments;

FIG. 9 shows a UE in accordance with some embodiments;

FIG. 10 shows a network node in accordance with some embodiments;

FIG. 11 is a block diagram of a host, which may be an embodiment of the host of FIG. 8, in accordance with various aspects described herein;

FIG. 12 is a block diagram illustrating a virtualization environment in which functions implemented by some embodiments may be virtualized; and

FIG. 13 shows a communication diagram of a host communicating via a network node with a UE over a partially wireless connection in accordance with some embodiments.

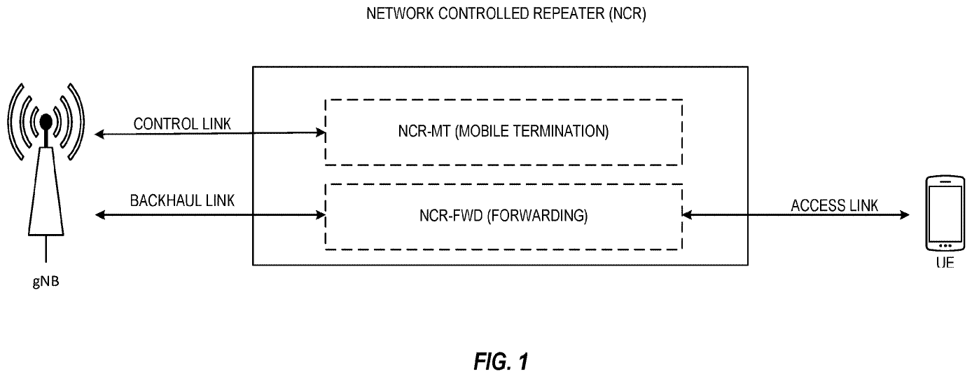

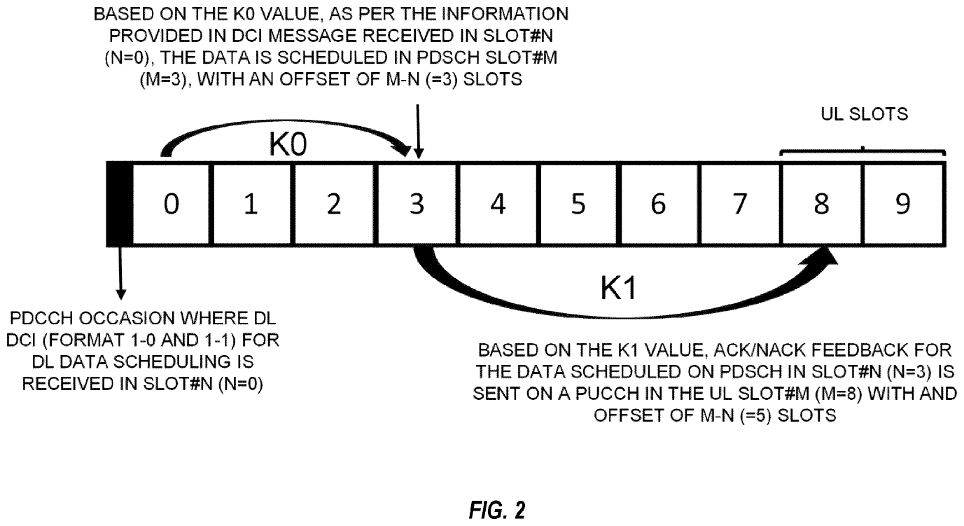

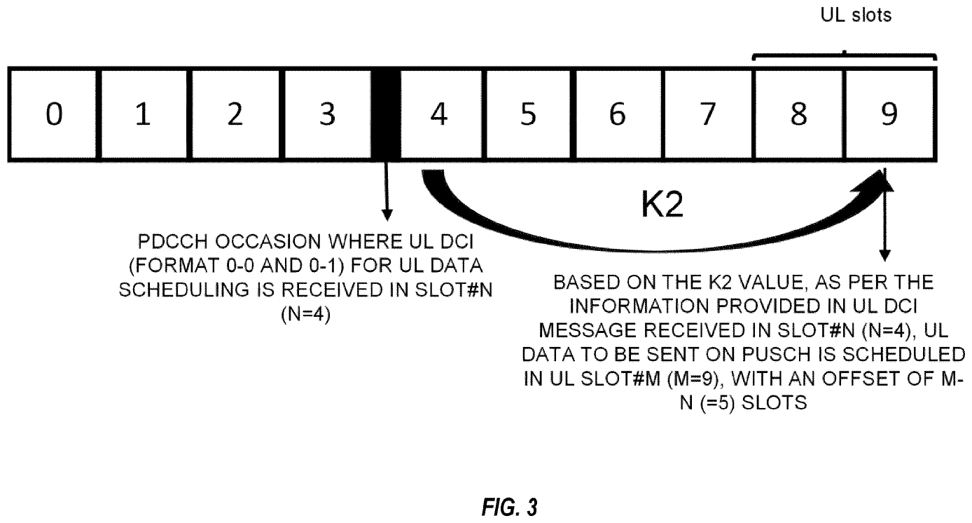

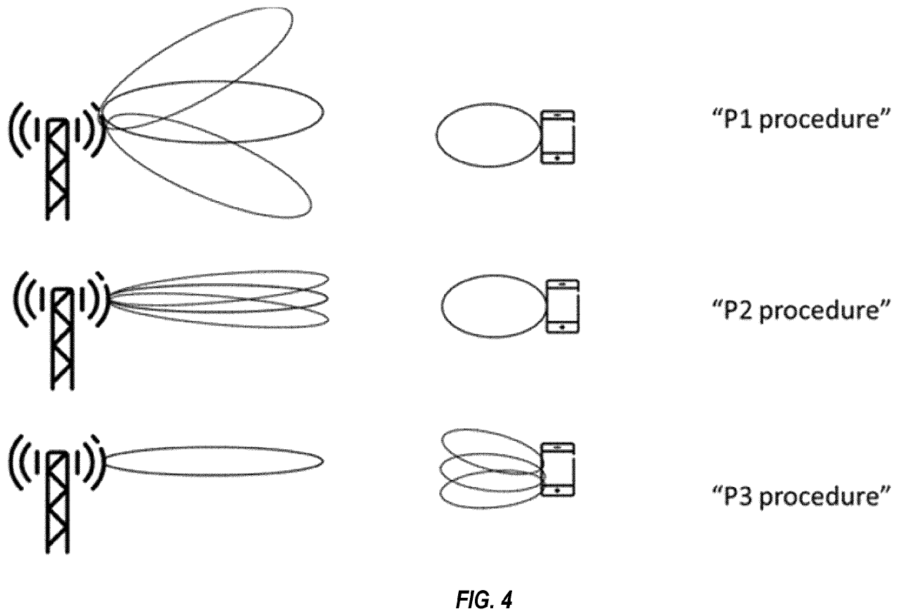

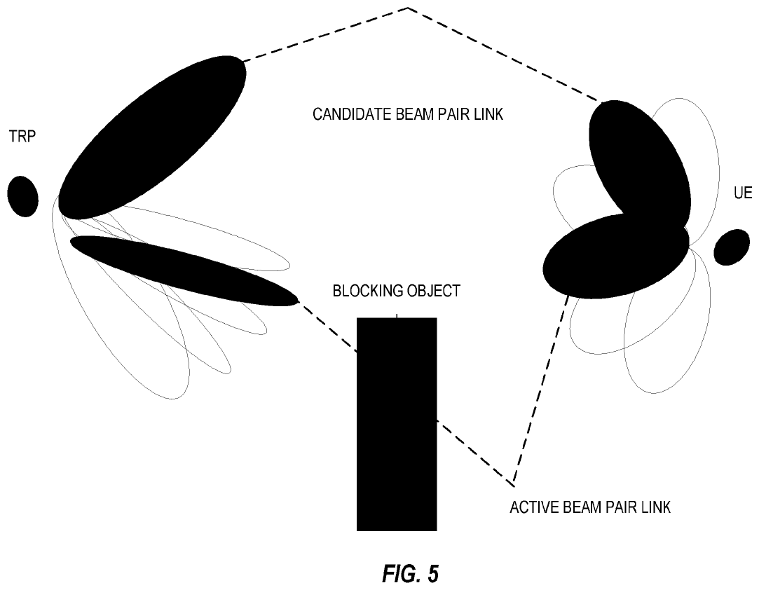

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

As used herein, the terminology “repeater node” refers to a network-controlled repeater or a Reconfigurable Intelligent Surface (RIS) or a node with similar types of functionality, i.e., receiving a signal and instantaneously forwarding it in another direction, unless otherwise stated.

To properly integrate the repeater node into the network and serve the User Equipments (UEs) through the repeater, one needs to determine the exact timing to switch between different beams of the repeater as well as the proper timing for switching between DL and UL and vice versa. This is particularly different from UEs/IAB nodes, because in the Network-Controlled Repeaters (NCRs)/RISs the received signal is directly forwarded with, e.g., some power amplification and/or phase rotation. It is expected that a fast connection is required between the network node (e.g., gNB) and the repeater, since the control signaling from gNB used to control the repeater will likely depend on the momentaneous scheduling decisions of the gNB. For example, in case gNB schedules data transmission for a certain UE, the NCR/RIS should preferably already be configured with a beam, communication direction and power allocation associated with that UE. In some embodiments, the exact timing of the used beam is used, since only when the right beams are used, can there be successful transmission/reception. If a UE is scheduled in a certain symbol X, the beam (at the repeater) that can be used for transmission/reception with the UE must be in place before the symbol starts and last at least one symbol (i.e., cover the UE scheduling period). Since it also applies for consecutive symbols with other scheduled UEs/beams, (potential) beams switching should be synchronized to symbols. It is the same synchronization question for the DL/UL switch (not for beams, but the proper switch between Tx and Rx mode).

As one of the main objectives of NCR study-item, the problem of timing and synchronization in repeater-assisted networks has been recently discussed in RAN1 #109-e [2]. One of the key points for proper synchronization is to consider the timing from reception to application of a particular configuration. In particular, there is a need for repeater latency signaling, which will allow the gNB to properly configure the repeater for synchronized communication to the UEs. That is, the gNB and the repeater should have a common view of switching timing. This is the motivation for some embodiments disclosed herein as described below.

There currently exist certain challenges. To benefit from the NCRs and RISs, proper synchronization is needed between the NCRs/RISs and the gNB. That is, the NCR needs to know, with a high accuracy, when a certain beam should be applied and when switching to a subsequent beam should take place. Particularly, different from, e.g., IAB-nodes or the UEs which receive the signal from a parent node as an end point, NCRs and RISs directly forward the received signal with some power amplification and/or phase rotation. Thus, once the gNB schedules data transmission for a certain UE, the NCR/RIS should synchronously be configured with a proper beam associated with that UE. To satisfy such a requirement, there is a need for repeater latency signaling, i.e., the repeater should inform the gNB about, e.g., how many slots/symbols it needs to decode and control a beam, such that the gNB can configure the NCR/RIS accordingly.

Systems and methods for repeater latency signaling are provided. In some embodiments, a method performed by a first network node for forwarding a signal to and/or from a User Equipment (UE) the method comprising: providing a repeater latency capability to a second network node; receiving a repeater side control information from the second network node; and applying the repeater side control information at an application time instant according to a latency configuration. In some embodiments, one or more of the latency configuration and the repeater side control information are related to one or more of repeater beam switching; repeater-Fwd ON/OFF; repeater power control; and control signal decoding. In some embodiments, the first network node comprises at least one of a repeater node, a Network Controlled Repeater (NCR); an Intelligent Reflecting Surface (IRS); a Reconfigurable Intelligent Surface (RIS); and a node with similar functionalities. In some embodiments, the second network node comprises at least one of a base station; an Integrated Access and Backhaul (IAB) node which has an assisting repeater node; and a gNB. In this way, the gNB can be informed about the Network-Controlled Repeater (NCR) latency and can have proper synchronization. Particularly, some embodiments enable the proper integration of the NCRs into the network and, hence, improve the coverage extension.

Certain aspects of the disclosure and their embodiments may provide solutions to these or other challenges. The goal of the present disclosure is to develop a method for proper synchronization between the NCR/RIS and the gNB taking the NCR\RIS internal delay into account. Particularly, some embodiments aim for a method that allows a common view of switching timing between the gNB and the repeater, which is obtained by specific configurations and utilizing information about the NCR/RIS latency. This addresses one of the main objectives of the Rel-18 study-item on NCRs [1] regarding the timing information to align transmission/reception boundaries of the NCRs/RISs. Particularly, embodiments disclosed herein address some of the FFSs from RAN1 #109-e meeting [2] to be discussed in the meeting RAN1 #110, as highlighted above.

Certain embodiments may provide one or more of the following technical advantage(s). The embodiments disclosed herein provide a method to inform the gNB about the NCR latency and, correspondingly, to have proper synchronization. This addresses one of the main objectives of the 3GPP Rel-18 study-item on NCRs, and is directly related to a number of FFSs to be discussed in the 3GPP meeting RAN1 #110-e. Particularly, the proposed scheme enables the proper integration of the NCRs into the network and, hence, improve the coverage extension.

In this way, one can determine when to apply a new configuration in the repeater nodes, and the gNB can communicate with the UEs through the repeaters with proper synchronization. This, in turn, enables proper integration of the repeaters into the network and increases the network coverage correspondingly.

In some embodiments, a method performed by a first network node for forwarding a signal to/from a user equipment includes one or more of: providing a repeater latency capability to a second network node; receiving a repeater indication from the second network node; and applying the indication at an application instant according to a latency configuration. In some embodiments, the method also includes receiving a latency configuration from the second network node. The “application instant” is sometimes referred to as an “applicant time instant.” The application time instant specifies when the indicated side control information should be applied, e.g., the starting symbol, slot or frame. In some embodiments, a repeater latency capability includes a minimum required latency. In some embodiments, the minimum required latency comes from the fact that, e.g., some time is required for processing a repeater indication before a conveyed configuration can be applied.

In some embodiments, a method performed by a second network node for communicating with a user equipment, includes one or more of: receiving a repeater latency capability from a first network node; determining a repeater indication; transmitting a repeater indication to the first network node; and transmitting or receiving a signal to the user equipment, via the first network node, according to a latency configuration.

In some embodiments, the second network node comprises one of the group consisting of: a base station; an IAB node which has an assisting repeater node; and a gNB. In some embodiments, the first network node comprises one of the group consisting of: a repeater node, a Network Controlled Repeater, NCR; an Intelligent Reflecting Surface, IRS; a Reconfigurable Intelligent Surface, RIS; and a node with similar functionalities.

In some embodiments, the method also includes receiving a latency configuration from the second network node. The latency capability is further related to one or more of repeater beam switching; repeater-Fwd ON/OFF; repeater power control; and control signal decoding. As used herein, “related to” can mean “apply to” as in where one or more of the latency configuration and the repeater indication are further related to one or more of repeater beam switching; repeater-Fwd ON/OFF; repeater power control; and control signal decoding.

In some embodiments, the method also includes receiving a latency configuration from the second network node. In some embodiments, the latency configuration and/or indication are further related to one or more of repeater beam switching (e.g., repeater-Fwd beam switching); repeater-Fwd ON/OFF; repeater power control (e.g., repeater-Fwd power control); and control signal decoding (e.g., side control signal decoding).

In some embodiments, the repeater capability indicates a minimum required latency. In some embodiments, the repeater indication may indicate an absolute application instant. In some embodiments, the latency configuration may indicate an absolute application instant. In some embodiments, the repeater indication may indicate an application instant in relation to reception instant of the indication. In some embodiments, the latency configuration may indicate an application instant in relation to reception instant of the indication. In some embodiments, the latency configuration may comprise one or more of a frame offset; a slot offset; and a symbol offset.

In some embodiments, the application instant can be implicitly or explicitly configured. In some embodiments, the indication relates to one of more of: Uplink, UL; and Downlink, DL. In some embodiments, the application instant further depends on the Time Domain Duplexing, TDD, direction, such that one or more of a DL slot is applied in relation to a DL timing reference; an UL slot is applied in relation to an UL timing reference; and an UL slot is applied in relation to a DL timing reference. In some embodiments, implicit indication is based on a repeater node capability report, meaning no dedicated signaling from the controlling gNB to UE. In some embodiments, it may still be a signaling from gNB to repeater.

In some embodiments, upon receiving the indication, transmitting an ACK to the second network node. In some embodiments, the transmitting of an ACK to the second network node occurs upon receiving and correctly decoding the repeater indication. In some embodiments, the first and/or second network node operates in a Fifth Generation, 5G, communications network.

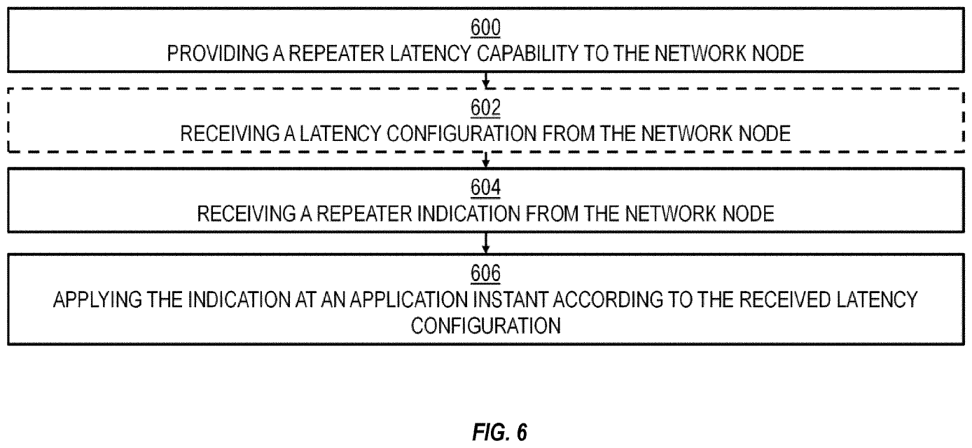

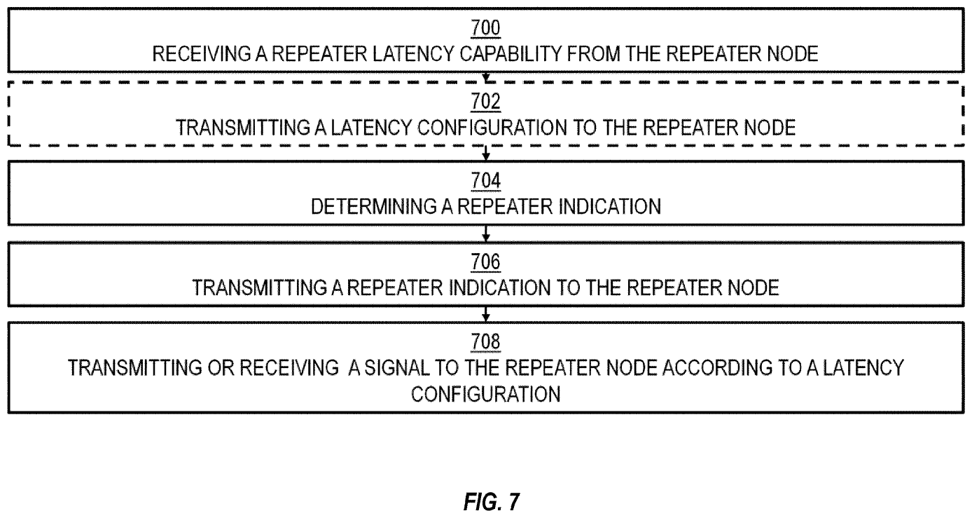

FIG. 6 and FIG. 7 illustrate the flowcharts of some embodiments from the repeater node and the gNB perspectives, respectively. In simple words, the proposed scheme is based on the following procedure: The repeater node receives an indication and optionally an explicit/implicit latency configuration, based on which the repeater forwards the signals with a configuration at an appropriate time. Here, there may be two different methods:

Method 1: Apply an indication change in relation to an absolute slot index, e.g., in the n-th slot of the m-th frame. In this case, it does not matter when, for instance, the indication arrives (within a window before the n-th slot of the m-th frame).

Method 2: Apply an indication in relation to when it is received. For instance, the indication is received at the m-th slot, and applied at, e.g., the (m+k)-th slot.

The details of the considered steps are as follows, whereas the different step from repeater perspective and from network node perspective are described together when suitable:

FIG. 6 illustrates a flowchart of some embodiments from the repeater perspective, according to some embodiments of the current disclosure. FIG. 7 illustrates a flowchart of some embodiments from the gNB perspective, according to some embodiments of the current disclosure. In a first Step 600 of FIG. 6, associated with Step 700 of FIG. 7, the repeater node provides the gNB with its latency capability. In some embodiments, providing includes sending the information to the gNB. In one embodiment, the capability report from the repeater to the gNB is related to the time information on, or delay of, e.g., repeater node's beam switching, repeater-Fwd ON/OFF, repeater node's power control and/or control signal decoding/processing, e.g., DCI decoding delay (e.g., side control signal decoding). In another embodiment, the repeater capability may indicate a minimum required latency, which could be a common or an individual minimum required latency for each dynamic indication. In some embodiments, control signaling decoding and the required time to do so is the reason for requiring delays/latency. In some embodiments, if powering ON the NCR FWD (after an OFF state) requires 5 symbols, the gNB cannot configure the NCR to apply a beam 3 symbols after receiving the configuration.

In some embodiments, the repeater indication contains a beam configuration. In some embodiments, the application timing of the configuration is n+k+offset. “n” is the reception time of the configuration. “k” comes from the latency capability (e.g., step 600) (e.g., “minimum required latency”), and “offset” comes in the repeater indication (e.g., step 604), as “slot/symbols offset.” In some embodiments, “n+k” is referred to as the “reference slot.” In some embodiments, k could be configured/provided by gNB based on UE capability report+some gNB side information, or alternatively only based on UE capability report.

In an optional Step 602 of FIG. 6, associated with the optional Step 702 of FIG. 7, upon receiving the capability, the gNB may further transmit a latency configuration to the repeater node. Here, the configuration may be related to, e.g., the repeater node's beam switching, the repeater-Fwd ON/OFF and/or the repeater node's power control. The gNB may configure the latency depending on how far in advance the UEs scheduling is applied or depending on scheduling decision, traffic pattern, UE buffer, long-term statistics, etc. Here, the latency configuration may indicate an absolute application instant. Note that, using this absolute time, there is no need to give a specific offset, just the gNB should ensure that the indication is provided in advance. Alternatively, the latency configuration may indicate an application instant in relation to reception instant of the indication. In this way, the gNB will inform the repeater node that in, e.g., n symbols it should have the specific beam x ready for transmission or, alternatively, the repeater is informed that in how many symbols later the gNB will send the repeater node a new signal to forward. In general, the configuration may comprise one or more of a frame, a slot or a symbol number, and/or offset.

In one embodiment, for different DL and UL transmissions, the repeater latency configuration may be determined by, e.g., following the same approach as for the K parameters in resource allocation principles in time domain (see above), SLIV values in the slot level or the S and L parameters in the symbol level, as explained above. Moreover, for different DL or UL transmissions, the latency configuration may depend on, for example, the sub-carrier spacing in PDSCH and PDCCH or the sub-carrier spacing of PUSCH and PDCCH. Alternatively, a fixed application time may be used. Note that, depending on if the signaling (e.g., latency configuration) only deals with rather fixed decoding processing time and beam switching time, particularly excluding dynamic scheduling time information, the application time may be a fixed relative offset. On the other hand, if the signaling (e.g., latency configuration, dynamic indication) may also include dynamic scheduling time information, then the application time can be varied. Finally, the latency configuration can include a single or a set of values.

In a Step 704 of FIG. 7, the gNB determines the repeater node indication. Here, the indication is determined based on the queued UE data in the gNB and/or the statistics based on previously transmitted UE data. In one embodiment, the statistics are updated based on actually transmitted or received data to a device or in a beam.

In a Step 604 of FIG. 6, associated with Step 706 of FIG. 7, the gNB transmits the repeater node, i.e., the NCR or the RIS, an indication (e.g., a repeater side control information). Here, the indication may relate to one of more of DL or UL symbols. In one embodiment, the indication may be related to, e.g., the repeater beam switching (e.g., Repeater-FWD beam switching), repeater-Fwd ON/OFF and/or repeater power control (e.g., Repeater-Fwd power control). The indication may use e.g., MAC-CE message, or DCI signaling etc. In some embodiments, the same type of indication cannot be provided by a choice of MAC or DCI. For instance, MAC can activate a semi-persistent beam indication, and DCI can indicate a dynamic beam indication. For a certain time instant (time resource, e.g., a symbol) these messages can indicate different beams. In which case, there are rules for priority (e.g., dynamic over semi-persistent). In some embodiments, if multiple indications of the same type are provided (e.g., two DCI/dynamic configurations), the later configuration supersedes.

The repeater indication may indicate an absolute application instant. Alternatively, the repeater indication may indicate an application instant in relation to the reception instant of the indication, e.g., in terms of frame offset, and/or slot offset, and/or symbol offset etc. In some embodiments, the repeater indication is referred to as repeater side control information. In some embodiments, side control information controls repeater-FWD and the operation of repeater-MT is similar to the legacy UE and follows the legacy signaling. Finally, upon receiving and correctly decoding the indication, the repeater node may transmit an ACK to the network node.

Finally, in a Step 606 of FIG. 6, associated with Step 708 of FIG. 7, the gNB exchanges signals with the device through the repeater node, and the repeater node applies the indication according to the received latency configuration. Here, the application instant is related to the reception instant of the indication and the configured latency. Note that the application instant can be implicitly or explicitly configured. Also, in one embodiment, the application of the indication instant is at earliest the minimum configured latency. Finally, in one embodiment, the application instant may depend on the TDD direction, such that a DL slot is applied in relation to a DL timing reference, an UL slot is applied in relation to an UL timing reference, or an UL slot is applied in relation to a DL timing reference.

In this way, one can determine when to apply a new configuration in the repeater nodes, and the gNB can communicate with the UEs through the repeaters with proper synchronization. This, in turn, enables proper integration of the repeaters into the network and increases the network coverage correspondingly.

In some embodiments, a source node (e.g., a gNB) communicates with one or more destination nodes (e.g., UEs) in wireless communication links that are relayed by one or more repeater nodes (e.g., network-controlled repeater or intelligent surface etc.).

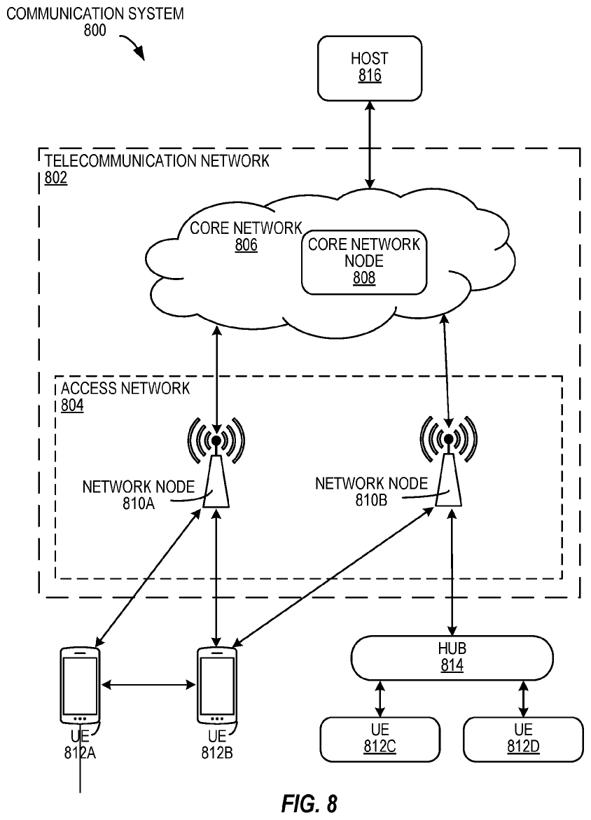

FIG. 8 shows an example of a communication system 800 in accordance with some embodiments.

In the example, the communication system 800 includes a telecommunication network 802 that includes an access network 804, such as a Radio Access Network (RAN), and a core network 806, which includes one or more core network nodes 808. The access network 804 includes one or more access network nodes, such as network nodes 810A and 810B (one or more of which may be generally referred to as network nodes 810), or any other similar Third Generation Partnership Project (3GPP) access node or non-3GPP Access Point (AP). The network nodes 810 facilitate direct or indirect connection of User Equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with one or more of the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be anon-dedicated hub—that is, a device which is capable of operating to route communications between the UEs and the network node 810B, but which is additionally capable of operating as a communication start and/or end point for certain data channels.

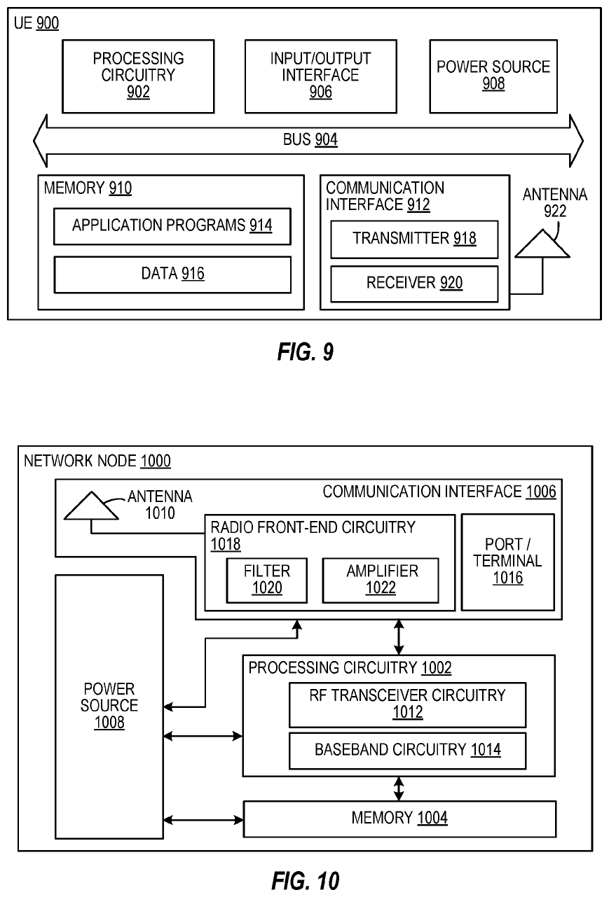

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof Δn input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

Specifically, the network node 1000 could be the implementation of the first network node (e.g., a repeater node, a NCR; an IRS; a RIS; or a node with similar functionalities) and the second network node (e.g., a base station; a gNB; or a node with similar functionalities).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, memory 1004, a communication interface 1006, and a power source 1008. The network node 1000 may be composed of multiple physically separate components (e.g., a Node B component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., an antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

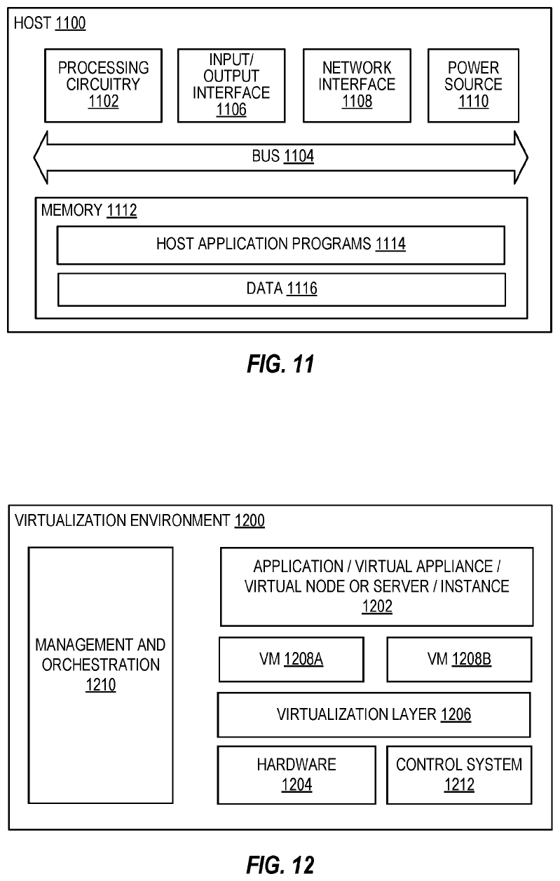

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g. data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1212 which may alternatively be used for communication between hardware nodes and radio units.

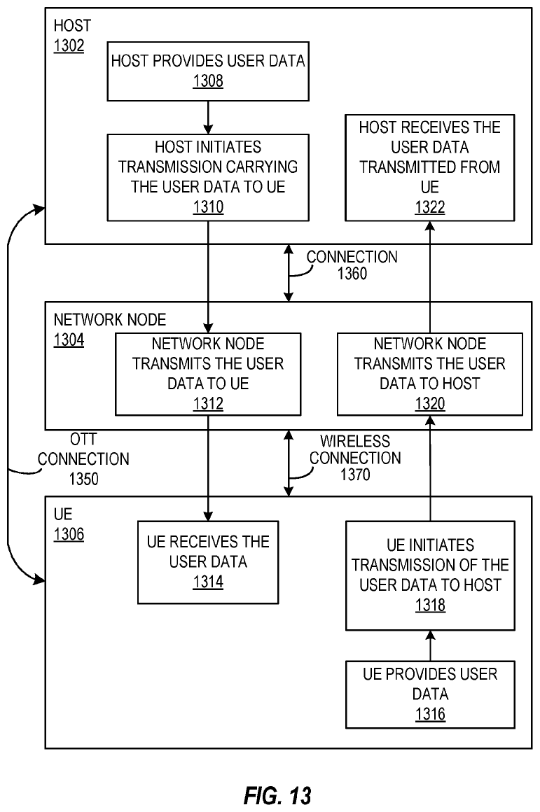

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306 via a connection 1360. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EMBODIMENTS

### Group A Embodiments

Embodiment 1: A method performed by a user equipment for communicating with a network node, the method comprising: a. receiving a signal, from a repeater node, forwarded from a network node according to any of the embodiments discussed herein.

Embodiment 2: The method of any of the previous embodiments, further comprising: providing user data; and forwarding the user data to a host via the transmission to the network node.

### Group B Embodiments

Embodiment 3: A method performed by a first network node for forwarding a signal to/from a user equipment, the method comprising one or more of: a. providing (600) a repeater latency capability to a second network node; b. receiving (604) a repeater indication from the second network node; and c. applying (606) the indication at an application instant according to a latency configuration.

Embodiment 4: The method of the previous embodiment, wherein the second network node comprises one of the group consisting of: a base station; and a gNB.

Embodiment 5: The method of any of the previous embodiments, wherein the first network node comprises one of the group consisting of: a repeater node, a Network Controlled Repeater, NCR; an Intelligent Reflecting Surface, IRS; a Reconfigurable Intelligent Surface, RIS; and a node with similar functionalities.

Embodiment 6: The method of any of the previous embodiments further comprising: receiving (602) a latency configuration from the second network node.

Embodiment 7: The method of any of the previous embodiments, wherein the latency capability is further related to one or more of: repeater beam switching; repeater-Fwd ON/OFF; repeater power control; and control signal decoding.

Embodiment 8: The method of any of the previous embodiments, wherein the latency configuration and/or indication are further related to one or more of: repeater beam switching; repeater-Fwd ON/OFF; repeater power control; and control signal decoding.

Embodiment 9: The method of any of the previous embodiments, wherein the indication may use e.g., a MAC-CE message, or DCI signaling.

Embodiment 10: The method of any of the previous embodiments, wherein the repeater capability indicates a minimum required latency.

Embodiment 11: The method of any of the previous embodiments, wherein the repeater configuration may indicate a minimum required latency.

Embodiment 12: The method of any of the previous embodiments, wherein the gNB configured “minimum required latency” is different from the repeater node reported “minimum required latency”.

Embodiment 13: The method of any of the previous embodiments, wherein the repeater indication may indicate an absolute application instant.

Embodiment 14: The method of any of the previous embodiments, wherein the latency configuration may indicate an absolute application instant.

Embodiment 15: The method of any of the previous embodiments, wherein the repeater indication may indicate an application instant in relation to reception instant of the indication.

Embodiment 16: The method of any of the previous embodiments, wherein the latency configuration may indicate an application instant in relation to reception instant of the indication.

Embodiment 17: The method of any of the previous embodiments, wherein the latency configuration may comprise one or more of: a frame offset; a slot offset; and a symbol offset.

Embodiment 18: The method of any of the previous embodiments, wherein the application instant can be implicitly or explicitly configured.

Embodiment 19: The method of any of the previous embodiments, wherein the indication relates to one of more of: Uplink, UL; and Downlink, DL.

Embodiment 20: The method of any of the previous embodiments, wherein the application instant further depends on the Time Domain Duplexing, TDD, direction, such that one or more of: a. a DL slot is applied in relation to a DL timing reference; b. an UL slot is applied in relation to an UL timing reference; and c. an UL slot is applied in relation to a DL timing reference.

Embodiment 21: The method of any of the previous embodiments, wherein, upon receiving and correctly decoding the indication, transmitting an ACK to the second network node.

Embodiment 22: The method of any of the previous embodiments, wherein the first network node operates in a Fifth Generation, 5G, communications network.

Embodiment 23: A method performed by a second network node for communicating with a user equipment, the method comprising one or more of: a. receiving (700) a repeater latency capability from a first network node; b. determining (704) a repeater indication; c. transmitting (706) a repeater indication to the first network node; and d. transmitting or receiving (708) a signal to the user equipment, via the first network node, according to a latency configuration.

Embodiment 24: The method of the previous embodiment, wherein the second network node comprises one of the group consisting of: a base station; and a gNB.

Embodiment 25: The method of any of the previous embodiments, wherein the first network node comprises one of the group consisting of: a repeater node, a Network Controlled Repeater, NCR; an Intelligent Reflecting Surface, IRS; a Reconfigurable Intelligent Surface, RIS; and a node with similar functionalities.

Embodiment 26: The method of any of the previous embodiments, further comprising: transmitting (702) a latency configuration to the first network node.

Embodiment 27: The method of any of the previous embodiments, wherein the latency capability is further related to one or more of: repeater beam switching; repeater-Fwd ON/OFF; repeater power control; and control signal decoding.

Embodiment 28: The method of any of the previous embodiments, wherein the latency configuration and/or indication are further related to one or more of: repeater beam switching; repeater-Fwd ON/OFF; repeater power control; and control signal decoding.

Embodiment 29: The method of any of the previous embodiments, wherein the indication may use MAC CE message, or DCI signaling.

Embodiment 30: The method of any of the previous embodiments, wherein the repeater capability indicates a minimum required latency.

Embodiment 31: The method of any of the previous embodiments, wherein the repeater configuration may indicate a minimum required latency.

Embodiment 32: The method of any of the previous embodiments, wherein the gNB configured “minimum required latency” maybe different from the repeater node reported “minimum required latency”.

Embodiment 33: The method of any of the previous embodiments, wherein the repeater indication may indicate an absolute application instant.

Embodiment 34: The method of any of the previous embodiments, wherein the latency configuration may indicate an absolute application instant.

Embodiment 35: The method of any of the previous embodiments, wherein the repeater indication may indicate an application instant in relation to reception instant of the indication.

Embodiment 36: The method of any of the previous embodiments, wherein the latency configuration may indicate an application instant in relation to reception instant of the indication.

Embodiment 37: The method of any of the previous embodiments, wherein the latency configuration may comprise one or more of: a frame offset; a slot offset; and a symbol offset.

Embodiment 38: The method of any of the previous embodiments, wherein the application instant can be implicitly or explicitly configured.

Embodiment 39: The method of any of the previous embodiments, wherein the indication relates to one of more of: Uplink, UL; and Downlink, DL.

Embodiment 40: The method of any of the previous embodiments, wherein the application instant further depends on the Time Domain Duplexing, TDD, direction, such that one or 20 more of: a. a DL slot is applied in relation to a DL timing reference; b. an UL slot is applied in relation to an UL timing reference; and c. an UL slot is applied in relation to a DL timing reference.

Embodiment 41: The method of any of the previous embodiments, wherein the configuration depends on the subcarrier spacing of PDSCH and PDCCH or the subcarrier spacing of PUSCH and PDCCH.

Embodiment 42: The method of any of the previous embodiments, wherein, upon the repeater receiving and correctly decoding the indication, expecting an ACK for the reception from the repeater node.

Embodiment 43: The method of any of the previous embodiments, wherein the determination is based on one or more of: queued UE data in the gNB; and statistics based on previously transmitted UE data.

Embodiment 44: The method of the previous embodiment, wherein the statistics are updated based on actually transmitted or received data to a device or in a beam.

Embodiment 45: The method of any of the previous embodiments, wherein the second network node operates in a Fifth Generation, 5G, communications network.

Embodiment 46: The method of any of the previous embodiments, further comprising: obtaining user data; and forwarding the user data to a host or a user equipment.

### Group C Embodiments

Embodiment 47: A user equipment for communicating with a network node, comprising: processing circuitry configured to perform any of the steps of any of the Group A embodiments; and power supply circuitry configured to supply power to the processing circuitry.

Embodiment 48: A network node for communicating with a user equipment, the network node comprising: processing circuitry configured to perform any of the steps of any of the Group B embodiments; power supply circuitry configured to supply power to the processing circuitry.

Embodiment 49: A user equipment (UE) for communicating with a network node, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 50: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 51: The host of the previous embodiment, wherein the cellular network further includes a network node configured to communicate with the UE to transmit the user data to the UE from the host.

Embodiment 52: The host of the previous 2 embodiments, wherein: the processing circuitry of the host is configured to execute a host application, thereby providing the user data; and the host application is configured to interact with a client application executing on the UE, the client application being associated with the host application.

Embodiment 53: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 54: The method of the previous embodiment, further comprising: at the host, executing a host application associated with a client application executing on the UE to receive the user data from the UE.

Embodiment 55: The method of the previous embodiment, further comprising: at the host, transmitting input data to the client application executing on the UE, the input data being provided by executing the host application, wherein the user data is provided by the client application in response to the input data from the host application.

Embodiment 56: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 57: The host of the previous embodiment, wherein the cellular network further includes a network node configured to communicate with the UE to transmit the user data from the UE to the host.

Embodiment 58: The host of the previous 2 embodiments, wherein: the processing circuitry of the host is configured to execute a host application, thereby providing the user data; and the host application is configured to interact with a client application executing on the UE, the client application being associated with the host application.

Embodiment 59: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 60: The method of the previous embodiment, further comprising: at the host, executing a host application associated with a client application executing on the UE to receive the user data from the UE.

Embodiment 61: The method of the previous embodiment, further comprising: at the host, transmitting input data to the client application executing on the UE, the input data being provided by executing the host application, wherein the user data is provided by the client application in response to the input data from the host application.

Embodiment 62: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 63: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 64: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 65: The method of the previous embodiment, further comprising, at the network node, transmitting the user data provided by the host for the UE.

Embodiment 66: The method of any of the previous 2 embodiments, wherein the user data is provided at the host by executing a host application that interacts with a client application executing on the UE, the client application being associated with the host application.

Embodiment 67: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 68: The communication system of the previous embodiment, further comprising: the network node; and/or the user equipment.

Embodiment 69: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 70: The host of the previous 2 embodiments, wherein: the processing circuitry of the host is configured to execute a host application, thereby providing the user data; and the host application is configured to interact with a client application executing on the UE, the client application being associated with the host application.

Embodiment 71: The host of the any of the previous 2 embodiments, wherein the initiating receipt of the user data comprises requesting the user data.

Embodiment 72: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 73: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core |
| 5GS | Fifth Generation System |
| AF | Application Function |
| AMF | Access and Mobility Function |
| AN | Access Network |
| AP | Access Point |
| ASIC | Application Specific Integrated Circuit |
| AUSF | Authentication Server Function |
| CPU | Central Processing Unit |
| DN | Data Network |
| DSP | Digital Signal Processor |
| eNB | Enhanced or Evolved Node B |
| EPS | Evolved Packet System |
| E-UTRA | Evolved Universal Terrestrial Radio Access |
| FPGA | Field Programmable Gate Array |
| gNB | New Radio Base Station |
| gNB-DU | New Radio Base Station Distributed Unit |
| HSS | Home Subscriber Server |
| IoT | Internet of Things |
| IP | Internet Protocol |
| LTE | Long Term Evolution |
| MME | Mobility Management Entity |
| MTC | Machine Type Communication |
| NEF | Network Exposure Function |
| NF | Network Function |
| NR | New Radio |
| NRF | Network Function Repository Function |
| NSSF | Network Slice Selection Function |
| OTT | Over-the-Top |
| PC | Personal Computer |
| PCF | Policy Control Function |
| P-GW | Packet Data Network Gateway |
| QoS | Quality of Service |
| RAM | Random Access Memory |
| RAN | Radio Access Network |
| ROM | Read Only Memory |
| RRH | Remote Radio Head |
| RTT | Round Trip Time |
| SCEF | Service Capability Exposure Function |
| SMF | Session Management Function |
| UDM | Unified Data Management |
| UE | User Equipment |
| UPF | User Plane Function |

Those skilled in the art will recognize improvements and modifications to the embodiments of the present disclosure. All such improvements and modifications are considered within the scope of the concepts disclosed herein.

1.-36. (canceled)

37. A method performed by a first network node for forwarding a signal to and/or from a user equipment (UE), the method comprising:
providing a repeater latency capability to a second network node;
receiving repeater side control information from the second network node; and
applying the repeater side control information at an application time instant according to a latency configuration,
wherein one or more of the latency configuration and the repeater side control information are related to one or more of the following:
repeater beam switching;
repeater forwarding (Fwd) ON/OFF;
repeater power control; and
control signal decoding.

38. The method of claim 37 further comprising: receiving the latency configuration from the second network node.

39. The method of claim 37, wherein the repeater latency capability is further related to one or more of the following: repeater beam switching; repeater Fwd ON/OFF; repeater power control; and control signal decoding.

40. The method of claim 37, wherein the repeater side control information is received via one or more of the following: a Medium Access Control (MAC) Control Element (CE) message; and Downlink Control Information (DCI) signaling.

41. The method of claim 37, wherein one or more of the following indicates a minimum required latency: the repeater latency capability provided to the second network node, and the latency configuration.

42. The method of claim 41, wherein the minimum required latency indicated by the repeater latency capability is different from the minimum required latency indicated by the latency configuration.

43. The method of claim 37, wherein one or more of the following indicates an application time instant in relation to a reception instant of the repeater side control information: the repeater side control information, and the latency configuration.

44. The method of claim 37, wherein one or more of the following applies:
the repeater side control information comprises one or more of the following: a frame offset; a slot offset; and a symbol offset; and
the application time instant is implicitly configured based on a repeater node capability report.

45. The method of claim 37, wherein the application time instant depends on a Time Domain Duplexing (TDD) direction, such that one or more of the following applies:
a downlink (DL) slot is applied in relation to a DL timing reference;
an uplink (UL) slot is applied in relation to an UL timing reference; and
an UL slot is applied in relation to a DL timing reference.

46. The method of claim 37, further comprising, in response to receiving the repeater side control information, transmitting an Acknowledge (ACK) to the second network node.

47. The method of claim 37, wherein:
the second network node comprises at least one of the following: a base station; an Integrated Access and Backhaul (IAB) node having an assisting repeater node; and a gNB; and
the first network node comprises at least one of the following: a repeater node, a Network Controlled Repeater (NCR), an Intelligent Reflecting Surface (IRS), and a Reconfigurable Intelligent Surface (RIS).

48. A method performed by a second network node for communicating with a user equipment (UE), the method comprising:
receiving a repeater latency capability from a first network node;
determining repeater side control information;
transmitting the repeater side control information to the first network node; and
transmitting or receiving a signal to the UE, via the first network node, according to a latency configuration,
wherein one or more of the latency configuration and the repeater side control information are related to one or more of the following:
repeater beam switching;
repeater forwarding (Fwd) ON/OFF;
repeater power control; and
control signal decoding.

49. The method of claim 48, further comprising transmitting the latency configuration to the first network node.

50. The method of claim 48, wherein the latency capability is further related to one or more of the following: repeater beam switching; repeater Fwd ON/OFF; repeater power control; and control signal decoding.

51. The method of claim 48, wherein the repeater side control information is transmitted via one or more of the following: a Medium Access Control (MAC) Control Element (CE) message; and Downlink Control Information (DCI) signaling.

52. The method of claim 48, wherein one or more of the following indicates a minimum required latency: the repeater latency capability provided to the second network node, and the latency configuration.

53. The method of claim 52, wherein the minimum required latency indicated by the repeater latency capability is different from the minimum required latency indicated by the latency configuration.

54. The method of claim 48, wherein one or more of the following indicates an application time instant in relation to a reception instant of the repeater side control information:
the repeater side control information, and the latency configuration.

55. The method of claim 48, wherein one or more of the following applies:
the latency configuration comprises one or more of: a frame offset; a slot offset; and a symbol offset; and
the latency configuration depends on a subcarrier spacing of one of the following channels: PDSCH, PDCCH, PUSCH, or PDCCH

56. The method of claim 48, wherein the application time instant depends on a Time Domain Duplexing (TDD) direction, such that one or more of the following applies:
a downlink (DL) slot is applied in relation to a DL timing reference;
an uplink (UL) slot is applied in relation to an UL timing reference; and
an UL slot is applied in relation to a DL timing reference.

57. The method of claim 48, further comprising, in response to transmitting the repeater side control information, receiving an Acknowledge (ACK) from the first network node.

58. The method of claim 48, wherein:
the second network node comprises at least one of the following: a base station; an Integrated Access and Backhaul (IAB) node having an assisting repeater node; and a gNB; and
the first network node comprises at least one of the following: a repeater node, a Network Controlled Repeater (NCR), an Intelligent Reflecting Surface (IRS), and a Reconfigurable Intelligent Surface (RIS).

59. A first network node configured to forward a signal to and/or from a User Equipment, UE, the first network node comprising:
processing circuitry and memory, wherein the memory comprises instructions that, when executed by the processing circuitry, cause the first network node to:
provide a repeater latency capability to a second network node;
receive repeater side control information from the second network node; and
apply the repeater side control information at an application time instant according to a latency configuration,
wherein one or more of the latency configuration and the repeater side control information are related to one or more of the following:
repeater beam switching;
repeater forwarding (Fwd) ON/OFF;
repeater power control; and
control signal decoding.

60. A second network node configured to communicate with a user equipment (UE), the second network node comprising:
processing circuitry and memory, wherein the memory comprises instructions that, when executed by the processing circuitry, cause the second network node to:
receive a repeater latency capability from a first network node;
determine repeater side control information;
transmit the repeater side control information to the first network node; and
transmit or receive a signal to the UE, via the first network node, according to a latency configuration,
wherein one or more of the latency configuration and the repeater side control information are related to one or more of the following:
repeater beam switching;
repeater forwarding (Fwd) ON/OFF;
repeater power control; and
control signal decoding.
